(19) United States
(12) Patent Application Publication
(10) Pub. No.: US 2012/0154239 A1
(43) Pub. Date: Jun. 21, 2012

(54) MILLIMETER WAVE RADIO ASSEMBLY WITH A COMPACT ANTENNA

(75) Inventors: Idan Bar-Sade, Santa Clara, CA (US); Eliezer Pasternak, Palo Alto, CA (US); Sean Samuel Cahill, Palo Alto, CA (US); Jorge de Jesus Delgadillo, San Jose, CA (US); Arne Lang-Ree, Los Gatos, CA (US); Richard Herms, Loomis, CA (US); Aaron Moncur, Mesa, AZ (US)

(73) Assignee: BRIDGEWAVE COMMUNICATIONS, INC., Santa Clara, CA (US)

(21) Appl. No.: 12/969,502

(22) Filed: Dec. 15, 2010

(51) Int. Cl. H01Q 19/10; H01Q 1/42

(52) U.S. Cl. 343/839; 343/872

(57) ABSTRACT

An integrated compact antenna device and method of aiming an electromagnetic signal using the integrated compact antenna device are described. The integrated compact antenna device be a vertically mounted cylinder enclosing an antenna, some electronic circuitry and most of the directional alignment mechanism. During alignment, the cylinder of the ICA rotates to provide azimuth. The cylinder is attached to a fixed base that remains stationary relative to the mounting structure.

### FIELD

This disclosure relates generally to the fields of microwave digital radio transmission and millimeter wave high gain antenna structures and alignment mechanisms.

### BACKGROUND

Digital cellular networks are evolving towards high speed data-centered mobile services. If, in the past, it was possible to evolve from one generation to another mainly by upgrading the base station equipment in the existing cell sites, the move towards so-called “4G” applications introduces coverage and spectrum capacity challenges that require augmenting the existing cell sites with mini cell sites of a much shorter range. These mini cell sites need to be installed in smaller spaces, including small boxes mounted on street light poles and similar utility structures. A common term for such mini cell sites is “Picocells”, which cover typically a radius of 200 m and provide aggregated data rate of 100 Mbps to 1 Gbps, possibly in multiple sectors and multiple spectral bands. Standards for such interfaces are WiMAX and Long Term Evolution (LTE).

These picocells require two-way communication links to transmit the data to the larger cell site or to a routing center. Ethernet links are typically used at speeds of 100 Mbps and 1000 Mbps. This transmission is known as “backhaul”. Backhaul is provided by several techniques including fiber optics, a microwave radio link using dedicated spectrum or some of the cellular spectrum, and line-of-sight millimeter wave (LOS-MMW). The benefits of LOS-MMW are high data rates, abundance of spectrum and lower cost than fiber optics. Digital LOS-MMW radio terminals with the desired capacity are commercially available, including from Bridgewave Communications, Inc. These terminals could provide the needed backhaul capacity for picocells as digital LOS-MMW radio terminals currently do in roof top and cell tower locations.

These digital LOS-MMW radio terminals have been successfully installed on street utility poles but some cities and carriers raise concerns about wide deployment in dense urban areas. A dish or flat panel antenna on typical digital LOS-MMW radio terminals raises objections from the public related to aesthetics and perceived radiation risks. In addition, installing a radio terminal requires trained personnel, especially during the step of aligning the antenna and some of these radios require licensing and spectrum coordination. Furthermore, since millimeter wave antennas use narrow beams, some links will not tolerate pole sway during wind. Some municipalities also limit the horizontal extension of antennas attached to street buildings' walls or poles, effectively prohibiting even the flattest antenna when this antenna is aligned to radiate diagonally from the wall's broadside direction.

All of the above concerns are addressed by the system and device described in the disclosure below and it is to this end that the disclosure is directed.

### BRIEF DESCRIPTION OF THE DRAWINGS

FIG. 1 shows light pole mounted picocells that have an integrated compact antenna (“ICA”) with millimeter wave backhaul in a dense urban environment;

FIG. 2 depicts some of the various mounting options for an ICA;

FIG. 3 shows a radio terminal including ICA;

FIG. 4 is a block diagram of an electronic function of an embodiment of a radio terminal with ICA;

FIG. 5 is a detailed view of a structure of an integrated compact antenna;

FIG. 6 is an external view of a fully assembled ICA with pole-mounting hardware;

FIG. 7 shows the geometry of locating a pivot point for the reflectors elevation behind the reflecting surface in a way that minimizes the cylinder's width of the ICA;

FIG. 8 is an exploded view of the reflector's assembly of the ICA;

FIG. 9 shows details of a dielectric window and a cylinder attachment of the ICA;

FIG. 10 shows an example of a stacked mounting of multiple ICAs; and

FIG. 11 shows an ICA with varying proportions relative to the fixed section.

### DETAILED DESCRIPTION OF ONE OR MORE EMBODIMENTS

The disclosure is particularly applicable to picocell millimeter wave digital radio backhaul applications as illustrated and described below and it is in this context that the disclosure will be described. It will be appreciated, however, that the system may be embodied in virtually any millimeter wave radio link and may be implemented using other known components that are all within the scope of the disclosure.

The disclosure is directed to an “Integrated Compact Antenna” device (“ICA”) that may be a vertically mounted cylinder enclosing an antenna, some electronic circuitry and most of the directional alignment mechanism as described below. During alignment, the cylinder of the ICA rotates to provide azimuth. The cylinder is attached to a fixed base that remains stationary relative to the mounting structure. The ICA device may be used with a millimeter wave link wherein millimeter waves are in the frequency range between 30 GHz and 300 GHz and any band within this range can be used with the ICA device. As an illustrative example, the range of 57 GHz to 64 GHz is used in the embodiments discussed below, commonly known as “the 60 GHz Band”.

Millimeter waves have unique sets of requirements and opportunities for integrating the antenna and alignment structure that are quite different from other electromagnetic radiation bands. The link budget, even for a few hundred meters, requires antenna gain in the order of 30-40 dBi and such gain is available only by “aperture antennas” such as horns, parabolic dish or flat panel array. Fortunately, a high aperture efficiency antenna at 60 GHz can exceed 30 dBi with an aperture diameter of 75 mm. The antenna is mounted inside the cylindrical structure and is radiating vertically and a reflector in the ICA deflects the beam to near-horizontal direction with adjustable elevation. Throughout this disclosure the propagation of electromagnetic waves is described as transmission or radiation from the antenna, but it should be emphasized that the reciprocal nature of the antenna and the reflecting and refracting media along the beam propagation path ensure that the same structures can be used also for reception of waves or for simultaneous transmission and reception. The overall look of the ICA is of a vertical cylinder, which blends into the urban environment in the proximity of utility poles and buildings. A radome material covers at least a fraction of the cylinder, effectively creating a dielectric material window, yet the direction of radiation is not noticeable to a casual observer, and if desired, can be completely hidden. Such antenna assembly must comply with electromagnetic requirements of a confined space and minimize the space overhead allocated for the reflector adjustment space. The reflector tilt mechanism should be hidden behind the reflector to minimize electromagnetic scattering from this mechanism, yet such off-plane rotation should maintain the low width of the external cylinder.

The rotating section of the cylinder (described below in more detail) may include at least the holding structure of the reflector, but might also include the antenna and radio front-end electronics. The ICA appears as a vertical cylinder structure that can be grabbed manually for rotation without a need to open and expose the antenna structure. Furthermore, nearly 360 degrees of azimuth are obtainable from coarse-angle mounting of the cylinder in a roughly desired direction relative to the fixed base (e.g. one fixed direction every 45 degrees) and then perform fine tuning manually by a smooth rotation, e.g. ±30 degrees. Externally, the structure looks about as thin as a light pole and it does not resemble a familiar microwave radiating aperture.

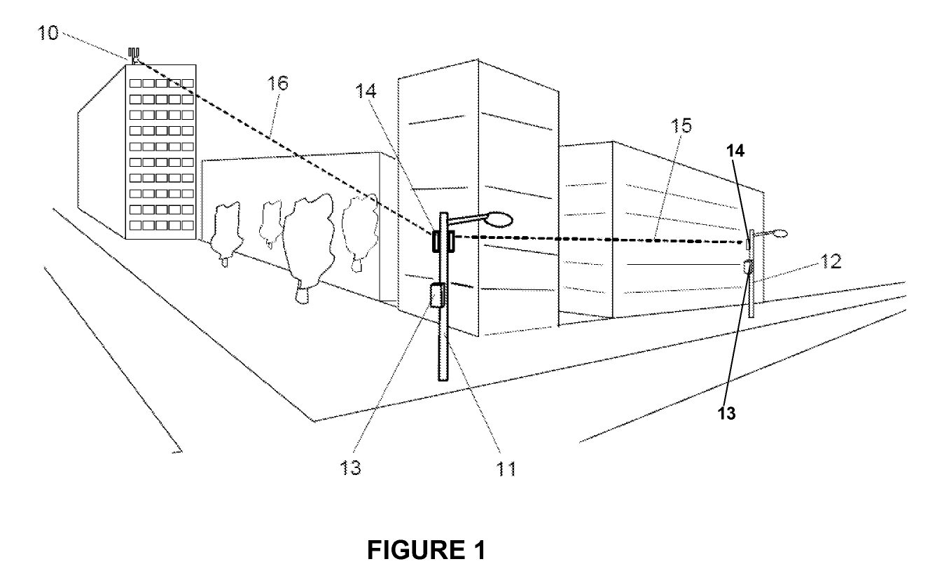

A picocell environment that could benefit from this ICA device is shown in FIG. 1. In the environment, a base station site 10 is augmented by a plurality of picocells 11 and 12 that each include a picocell box 13 and a backhaul radio 14 which might be designed in accordance with this disclosure. The picocell site 12 has no line of sight to the base station 10, thus another millimeter wave link 15 is established with the picocell 11 that acts as relay station and transmits the aggregate local and remote traffic to the base station 10 via a link 16. With 4G cellular services, the link 16 may be required to carry traffic exceeding 100 Mbps. While the base station 10 can use a conventional dish antenna for the link 16, the urban requirements for compactness of the picocells 11 and 12 are clear. These requirements apply as well to the picocell box structure 13 and the related radio access network (RAN) antennas (part of the backhaul radio 14), however the mobile components are outside the scope of this disclosure. For purposes of disclosure, the RAN antennas are in the bands of 700 MHz to 5 GHz and are nearly omni directional so that the techniques of minimizing the visual impact of such structures are very different from the aperture antennas required at the millimeter wave electromagnetic radiation spectrum.

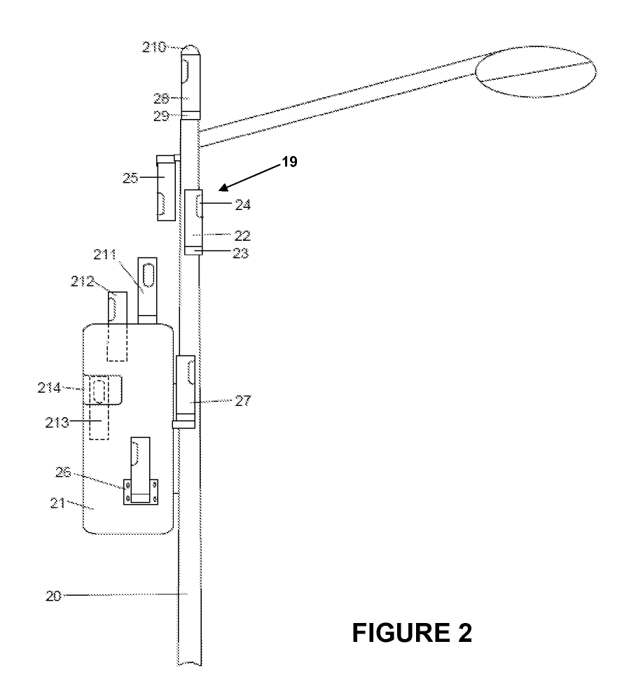

The ICA device that is part of the backhaul radio 14 maintains a low profile that resembles the diameter of a light pole, yet no alignment structure is visible externally. Some of the mounting options of the ICA are depicted in FIG. 2. As shown in FIG. 2, a light pole 20 is equipped with a picocell box/enclosure 21, that may be located above the height of people and street vehicles. An ICA device 19 (several of which are shown in FIG. 2 to show the different mounting positions although a typical installation may have fewer ICA devices 19 mounted onto any particular structure) may include a rotate-able cylinder 22, a base 23 removable attached (but fixed relative to the structure once the mounting mechanism is tightened) to a structure, such as the light pole 20, and at least a small dielectric window 24 from which the millimeter wave electromagnetic radiation emanates. The mechanism to attach the base 23 to the structure 20 is not shown since the attachment mechanism may be existing mounting methods, such as brackets, screws or circular bands and various mounting may be used for the ICA device. Similarly, the ICA device 19 may be mounted at various locations and orientations, such as on a pole-side mounting upside down 25, in the proximity of the picocell 21 on a side wall 26 of the enclosure of the picocell, or partially hidden between the picocell 21 and the pole 20 attached to either the picocell or the structure 20 (27). The ICA device 19 can also be mounted on the pole top; using a base structure 29 as a mechanical adaptor for a pole cap-like mounting, yet the pole top bird deterrent dome 210 can be mounted on top of the ICA. The ICA device 19 may also be mounted in a Picocell top mounting 211, partially enclosed within the picocell mounting location 212, and fully enclosed within the picocell mounting location 213 with the fully enclosed mounting requiring a dielectric window 214 in the general direction of radiation.

The great versatility of mounting options for the ICA device 19 and the allowed proximity to the structure 29 are realized due to the rotational symmetry of the cylinder 22, which does not change in external orientation at any alignment of azimuth or elevation. While the window 24 is emphasized in the drawing, this window can be made completely invisible either by extending it horizontally to the entire circumference of the cylinder or by covering it with a ring of thin microwave-compatible fabric such as the commercial Dacron.

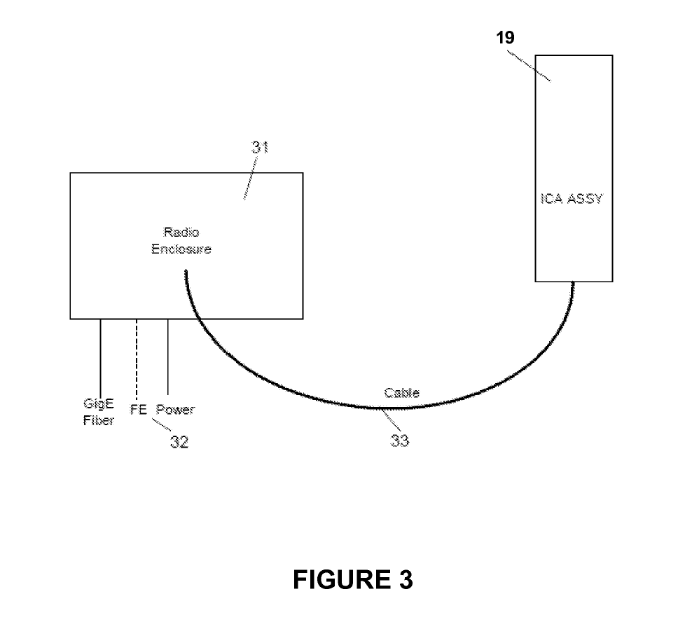

The electronic functions of the radio terminal can be divided to two or more section for convenience of implementation. For example, the ICA device 19 in FIG. 3 might contain the millimeter wave radio front end, while the intermediate frequency (IF) and other radio functions are located inside another enclosure 31 with the needed interfaces 32 and a link 33 between the ICA 19 and enclosure 31. The enclosure 31 can be a conventional environmentally protected radio boxes that can be mounted on the pole, a wall or inside the Picocell box. If the distance between the ICA 19 and radio enclosure 31 is limited to a few meters, the link 33 may be a cable and might consist of a pair of coax cables with SMA connectors; one for transmit intermediate frequency (TX IF)/baseband signals and one for receive intermediate frequency (IF) signals. Alternatively or in addition, the link 33 might include multiple conductors for the various DC bias and telemetry monitoring signals in the ICA 19, such as a thermistor for temperature and a tuning voltage for the radio head local oscillator. For the few-meter distance between the ICA 19 and radio enclosure 31, cables used in Ethernet applications might be adopted, where some might need thicker copper conductors, e.g. industrial thickness of 22 AWG. The ICA 19 cannot be a purely passive antenna as can be done at lower frequencies since extending millimeter wave signals is not practical.

On the other hand, the ICA 19 might contain the entire radio electronic functions, leaving the link/cable 33 to include power and external interfaces 32. In this case, the cable 33 goes directly to the picocell 21 (shown in FIG. 2) and interfaces directly with the picocell power and backhaul interfaces.

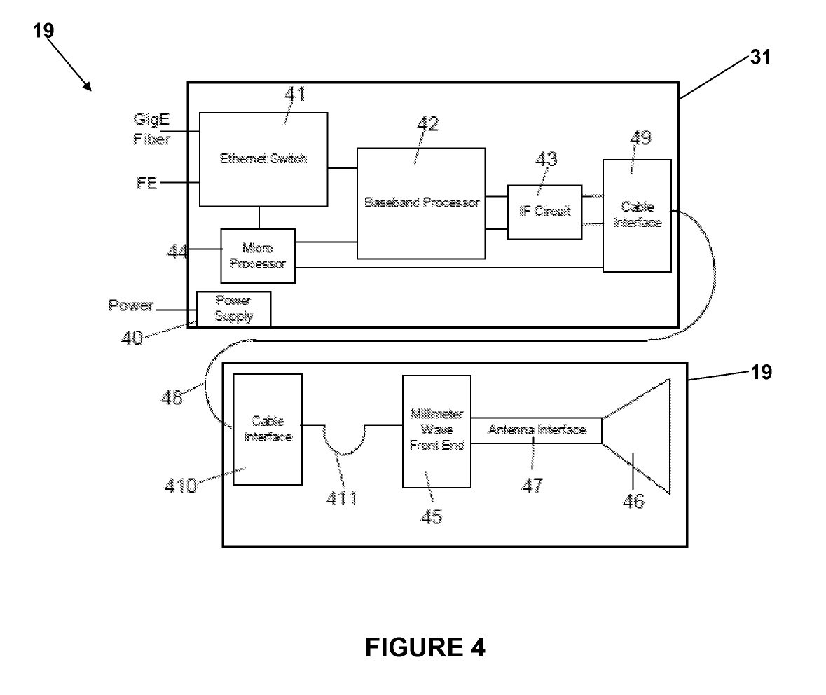

An embodiment of the ICA device 19 for longer cable distances is shown in FIG. 4. In this embodiment, a main radio circuit in the enclosure 31 may include a power supply 40, an Ethernet switch 41, a baseband processor 42 performing signal processing functions, intermediate frequency (IF) circuits 43, a processor 44, such as a microprocessor and other subsystems not shown as they are well known to radio design engineers. The ICA device 19 includes an electromagnetic energy front end 45, such as a millimeter wave front end in one embodiment, attached to an antenna 46, such as a millimeter wave antenna in one embodiment, via an antenna interface 47. The electromagnetic energy front end 45 includes a final transmit power amplifier and a first stage of receive amplifier (not shown) and these functions are necessary because millimeter waves cannot be extended to the main radio without sacrifice in performance. In addition, the electromagnetic energy front end 45 may include an frequency up conversion on the transmit side and a down conversion on the receive side which are well known and not shown in FIG. 4. The up conversion can be done from IF frequency or from baseband, depending on the modulation scheme in use, which might include FSK and QAM. All of the above radio building blocks in FIG. 4 are not specific to the ICA design and are knowledgeable to those skilled in the art. It is also common to use a single coaxial cable 48 to serve all the power and signals that are being exchanged between circuits in the enclosure 31 and the radio front-end 45 in the ICA device 19. A special cable interface circuit 49, 410 may be used on the enclosure side 19 and ICA device 19 side, respectively to perform such functions, which include DC or AC power transmission from the main to the ICA, IF filtering for each side and voltage biasing and telemetry for the front-end components. Since the front-end 45 is rotating with the ICA antenna 46 in some embodiments, a cable 411 between the interface 410 and the front end 45 has to be flexible. Because of the short distance of a few centimeters between the two subsystems and because the frequencies exchanged can be designed to be below 6 GHz, thin coax cables can transfer the IF frequencies and thin-flexible signal wires can transfer the various bias voltages and telemetry signals involved. The antenna interface 47 is usually waveguide based and may include conversion from rectangular to circular waveguide and if desired, a converter from linear to circular polarization and these devices are commercially available at millimeter wave frequencies.

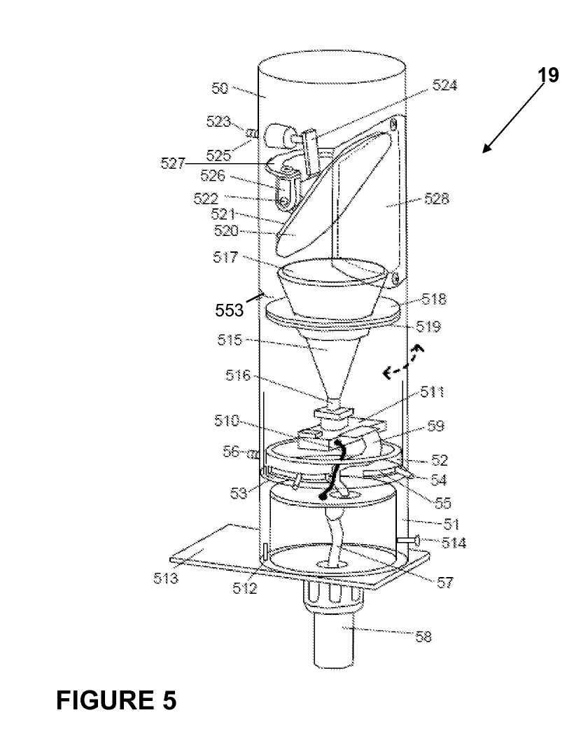

The structure of the ICA 19 is shown in FIG. 5. In FIG. 5, some elements are arbitrarily depicted transparent to expose other parts and also some walls and fasteners are not shown with the intent to maintain clarity. A main cylinder 50 of the ICA device 19 interfaces with a pole adaptor cylinder 51 that includes a narrower interface section 52. The external interface between the two cylinders is the line 53 shown in FIG. 5 which is not a physical line in the ICA device 19. A set of one or more bearing point screws 54 extend from the cylinder 50 into a groove 55 inside the narrower section 52 to allow rotational movement of the cylinder 50 with limit of about ±30 degrees. A tightening mechanism 56, such as a thumb screw, allows tightening of the cylinder 50 when adjustment of the antenna (described below in more detail) is complete. A cable 57, possibly entered via a duct 58 as shown in FIG. 5, is connected to an ICA cable Interface which was discussed in conjunction with item 410 in FIG. 4, and might consist at minimum one connector between the cable 57 and Interface Circuit. A set of flexible cables 59, 510 provide the same function as described for cable 411 in FIG. 4. The cable 510 is an example of IF signal coaxial cable connecting the circuits of the enclosure with the RF front end 511 (shown in FIG. 4 as front end 45.) Both cables 59, 510 allow the RF front end 511 to rotate together with the cylinder 50 throughout the entire range set by the grooves 55 and screws 54.

Both cylinders 51 and 50 are made of aluminum. The top cylinder 50 has thickness of about 5 mm and the bottom cylinder 51 of 10 mm, allowing a set of larger mounting screws 512 from the bottom. The bottom cylinder 51 is connected to a mounting plate 513 wherein the cylinder 51 and the mounting plate 513 form the bulk of the fixed section of the ICA device 19. During installation, the cylinder 51 can be placed in any coarse fixed angle orientation relative to the plate 513, e.g. 0.45 degree steps so that the ICA device 19 can achieve 360 degrees of azimuth with a combination of coarse angle fixing and fine tuning. In the case of pole top mounting (as shown in FIG. 2), the cylinder 51 slides directly on top of a pole, as shown in FIG. 2, and is tightened by a set of one or more side screws 514 (which are shown in FIG. 5, but may only be used or exist in applications in which a pole top mounting is being used.) Furthermore, since pole tops may vary in size and shape, customized bottom shapes of the cylinders 51 may be required. In a hollow pole top mounting, the plate 513 and duct 58 are not required since the cable might run inside the pole and connect directly to sites on the interface 58.

An aperture antenna (antenna) 515 is attached to the RF front end/head 511 via a waveguide adaptor 516 that provides the desired polarization matching as is well known. In some embodiments, the antenna 515 may have a circular waveguide 516, lowering the ICA overall radiated waves to assume vertical or horizontal polarization based on the relative position of the antenna 515 and the RF front end/head 511. The antenna 515 may be a horn antenna with lens correction, known as a “lens-corrected horn” wherein the lens (not shown) is located near an aperture 517 of the antenna and is mounted to the cylinder 50 by a flange 518 attached to a mounting ring 519. Other aperture antennas, such as a parabolic reflector cassegrain antenna also could be used instead with the same orientation, however lens horns provide better aperture efficiency thus would result ICA with lower width/gain ratio.

The radiation generated at the aperture 517 is a vertically propagating plane wave. The ICA device 19 may include a reflector structure with a reflector and a tilt adjustment mechanism that deflects the vertically propagating plane wave to a nearly horizontal beam. In one embodiment, the reflector may comprise a flat reflecting surface 520 which is the front plane surface of a reflector structure 521 and acts affectively as a mirror. The tilt adjustment mechanism tilts the reflecting surface 520 around an pivot point/axis 522 to provide elevation adjustment of the radiated beam (to generate an elevation angled propagating wave) using a elevation adjustment mechanism. The elevation adjustment mechanism may include a tuning thumb screw 523 that pushes against a spring loaded adjuster target 524 rigidly attached to the reflector assembly 521. A set of one or more ring-shaped marks 525 on the screw 523 provide external indication of the reflector tilt.

The reflecting surface 520 can be gold-plated brass. For the typical millimeter wave 60 GHz band, the flatness error of the surface 520 should be less than 0.1 mm and the RMS surface roughness error should also be about 0.1 mm. These dimensions are readily available with standard machining. For cost reduction, other surfaces have been confirmed experimentally to perform satisfactorily. Those include an aluminum reflector 521 with clear powder coating or anodization. The powder coating is preferred for its low cost and durability. The reflector axis 522 is held by two mounting blocks 526 attached to the cylinder 50 via a support ring 527. The radiated beam is passing through a window 528, such as a dielectric window, shaped like cylinder section. A dielectric of ABS plastic of 2 mm thickness may be used.

While the rotating cylinder interface 52 is placed near the bottom of the cylinder in the embodiment shown in FIG. 5, another embodiment of the ICA device 19 has the antenna 515 in the fixed section 51 which may extend upwards, moving the interface location 53 to a location 553 above the antenna mounting rings 518. Such option reduces the size of the moving cylinder, allowing thinner and lighter cylinder material and easing the design constraints of making the entire moving cylinder out of plastic, thus obviating the need for a separate window 528. Such option requires caution with polarization choice. Since the antenna 517 is fixed, the radiated polarization will rotate with the fine-tuning angle adjustment. This is either tolerated as a small loss in link budget, but it is also possible to radiate circularly polarized beam that will not be affected by azimuth rotation.

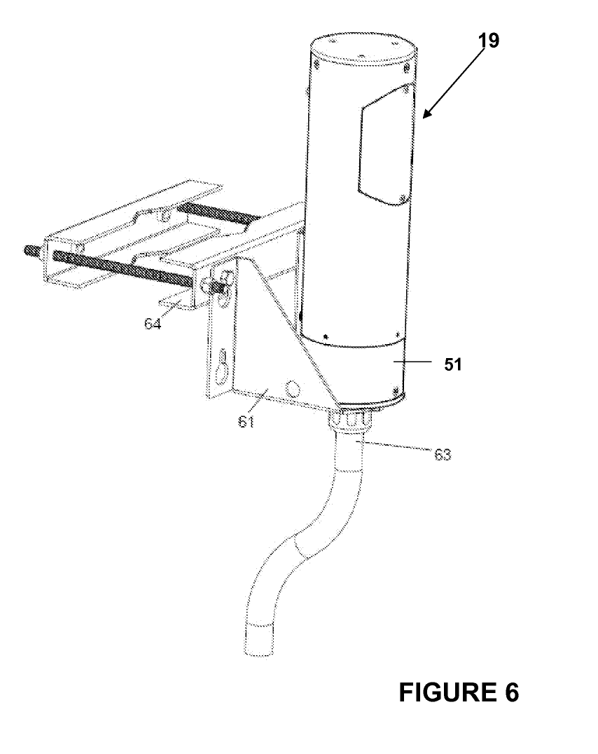

FIG. 6 shows the external view of an ICA structure 19 with a choice of mounting hardware. In particular, a mounting bracket 61 holds the fixed cylinder and cable/duct assembly 63 and this bracket can be attached to a set of pole-brackets 64. The design of the mounting hardware is not ICA-specific since any technique to fasten the fixed section 51 to a structure, such as a pole or wall, can be used. For example, the bracket 61 can be modified for pole attachment with a ring metal belt surrounding the pole instead of the brackets 64.

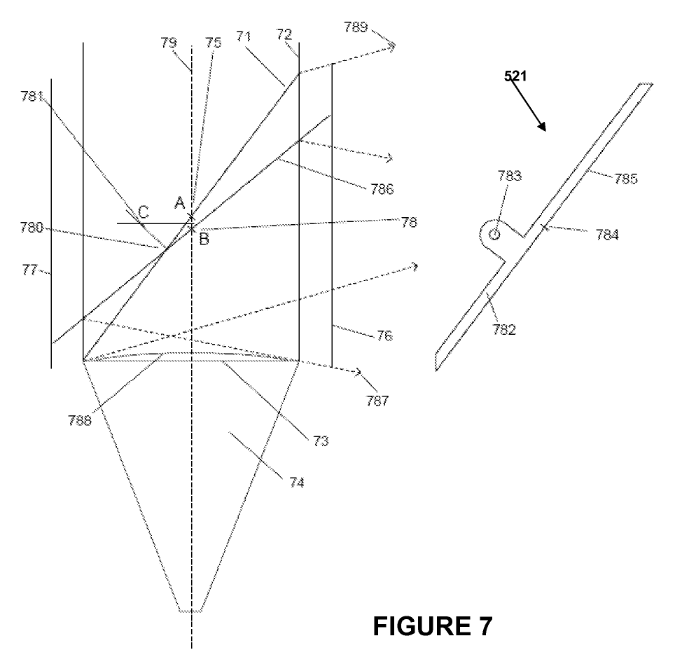

The geometry of the reflector structure 521 is shown in FIG. 7. The reflector is elliptically shaped with the long axis determined by a highest desired deflection position 71 relative to a vertical ray 72 emanating from the front edge of the antenna 74 aperture 73 (antenna aperture 517 in FIG. 5). The center of this long axis is marked by point A 75. The minimum possible cylinder width in the internal walls is determined by the same long axis tilted down 786 and nearly hitting the cylinder walls 76 and 77. The axis remains centered but the center moves down to a point B 78. This tilt-driven center lowering allows placing the rotation center at a point C 781 behind the reflector surface 71 (reflecting surface 520 in FIG. 5.) A cross section via the reflector 782 (reflector structure 521 in FIG. 5) shows a rotation axis 783 behind the reflector and lower than the main axis center 784 along the reflecting surface 785 (reflecting surface 520 in FIG. 5.) The placement behind reduces the cost of fabricating the reflector and also reduces the side lobes radiation possible by the axis hardware interacting with the radiated beam. To locate the axis point C, two lines are drawn. One line is the horizontal bisector of the vertical section between the points A and B, and the other is the obtuse angle bisector of between the maximum 71 and minimum 786 reflector orientations. These two lines meet at point C, which is an optimum for minimizing the window's width. It should be noted that there is some freedom in locating the point B below A, however as shown, B is the lowest possible location since further lowering of B would cause the lowest edge of the radio beam 787 to be blocked by the aperture 73 or lens 788, thus with B placed at the lowest possible non-blocking location the location of the point C is unique. Given the lowest beam 787 and the highest beam 789, the height of the dielectric window is determined as the line 76. As an example, the tilting range of the radiated electromagnetic beam outside the ICA might be from −10 degrees to +16 degrees above the horizon. These requirements set the reflecting surface high position 786 to be 45+16/2=53 degrees and the lowest position 786 at 45−10/2=40 degrees.

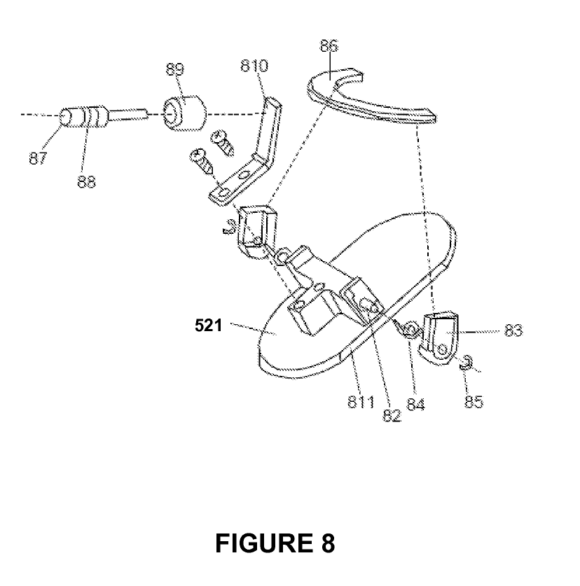

The reflector structure 521 is shown in exploded view in FIG. 8. The reflector 521 includes an axis 82 which fits the bracket 83 and springs 84. The axis is held by a C-clip 85. The bracket is attached to the ring 86 which is a horseshoe section of a ring 86 (also shown as element 527 in FIG. 5.) A tuning screw 87 with alignment indication ring marks 88 (the set of one or more ring-shaped marks 525 on the screw 523 in FIG. 5) may be screwed to a threaded insert 89 attached to the main rotating cylinder and hitting a target 810 (adjuster target 524 in FIG. 5) which is fastened to the reflector 521. The narrow axis of the reflecting surface may be the aperture width 73 in FIG. 7. The reflector 521 may be size reduced by clipping the ellipse on the sides 811 to about the width of the radiating aperture, since the radiated beam obeys geometrical optics rules to a good approximation for the typical dimensions involved in the ICA design.

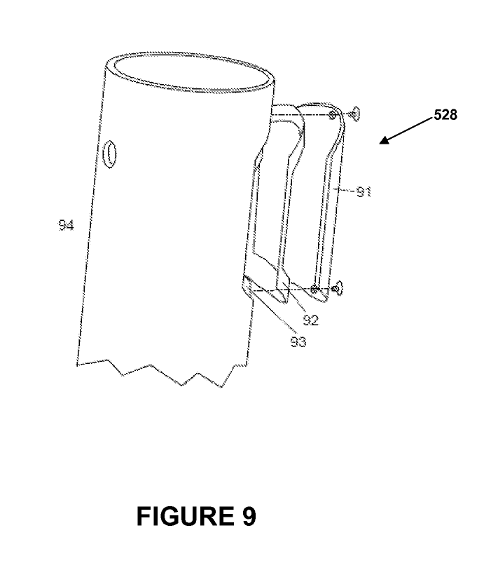

The dielectric window 528 is further shown in FIG. 9. The dielectric window may have a window 91 that may be made of ABS plastic and the 2 mm thickness of the window 91 is approximately one half wavelength at 60 GHz radiation that passes through the dielectric. Since the radiated beam is a plane wave, the radial cross section of the window provides varying transit thickness in the beam direction through the window, however maintaining fixed radial thickness was found satisfactory. The dielectric window may also have a sealing adhesive tape 92 that allows attaching the window 91 to a detent 93 in the cylinder 94 (cylinder 50 in FIG. 5.)

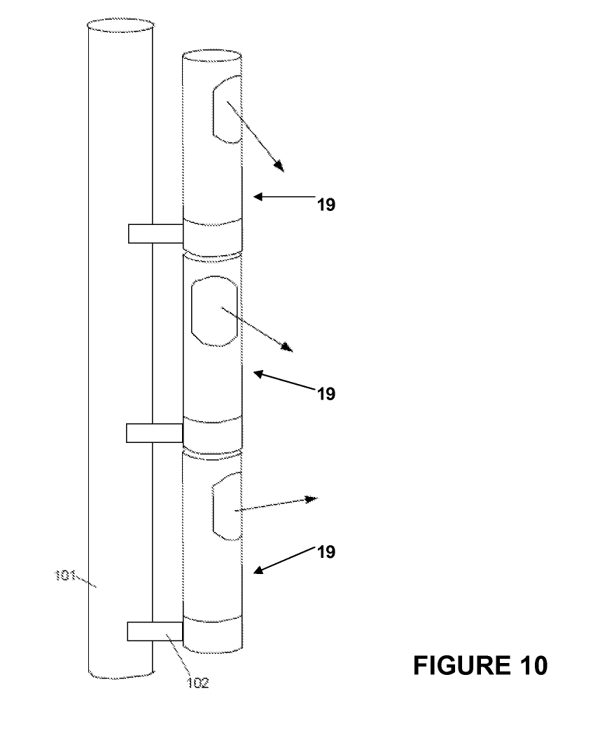

The compact cylinder ICA design allows stacking multiple ICA devices on a single pole as shown in FIG. 10. Such design reduces the “antenna farm” clutter on building roofs allowing what appears visually as a single rod antenna to contain multiple independently directed beams as shown by the arrows which indicate the radiation direction of each antenna in each ICA device 19. The cabling for these multiple ICA devices 19 may be provided along a mounting structure 101, such as a pole, and a set of attachment brackets 102.

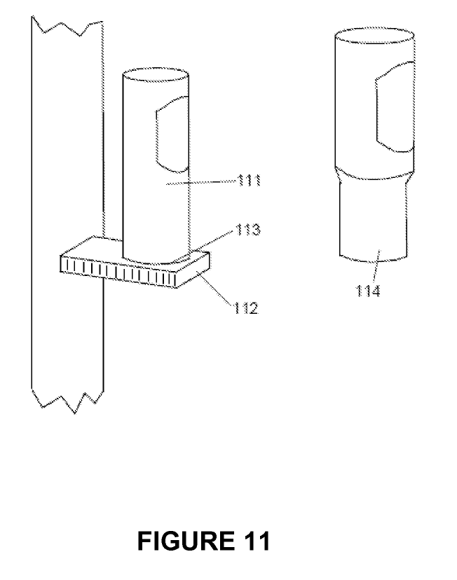

Other shapes for the ICA device 19 are possible as shown in FIG. 11. In one alternative embodiment, the rotating cylinder 111 (rotating cylinder 50 in FIG. 5) can interface with a larger fixed base 112 via a rotation interface 113. In this alternative embodiment, radio terminal electronics of a larger volume may be integrated into the ICA device 19 due to the perspective change. In yet another alternative embodiment, the rotating cylinder 114 might also vary the radius along the height to reduce the volume where not needed.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A compact electromagnetic energy antenna assembly, comprising:
a housing that blends in with a structure on which it is attached;
an interface, associated with the housing, to a signal source wherein the interface receives a signal from a remote signal source;
an electromagnetic energy front end that generates an electromagnetic energy signal based on the received signal;
an electromagnetic energy antenna located inside of the housing, coupled to the electromagnetic energy front end, that generates a vertically propagating wave;
a reflector structure, inside of the housing, that reflects the vertically propagating wave at a selected elevation angle to generate an elevation angled propagating wave; and
wherein the housing is rotatable and the reflector structure is adjustable to change an alignment of the elevation angled propagating wave.

2. The assembly of claim 1, wherein the housing is cylindrical.

3. The assembly of claim 1 further comprising a base, connected to the housing so that the housing can rotate relative to the base, that is securely fastened to a structure onto which the assembly is fastened.

4. The assembly of claim 1, wherein the interface is a cable.

5. The assembly of claim 1, wherein the electromagnetic energy front end further comprises a millimeter wave electromagnetic energy front end.

6. The assembly of claim 5, wherein the millimeter wave electromagnetic energy front end operates at a frequency band within the range of about 30 gigahertz to about 300 gigahertz.

7. The assembly of claim 1 further comprising a window, on an exterior surface of the housing, that allows the elevation angled propagating wave to exit the housing.

8. The assembly of claim 7, wherein the window is a dielectric window.

9. The assembly of claim 8, wherein the dielectric window is made of 2 mm thick ABS plastic.

10. The assembly of claim 1, wherein the reflector structure further comprises a reflector surface that reflects the vertically propagating wave at the selected angle and a reflector tilt mechanism located behind the reflector surface to minimize scattering of the elevation angled propagating wave.

11. The assembly of claim 1, wherein the electromagnetic energy front end and the electromagnetic energy antenna are located inside of the housing.

12. The assembly of claim 1, wherein the housing is capable of being mounted at one or more different locations on a structure.

13. The assembly of claim 1 further comprising a tightening mechanism that is tightened to prevent rotation of the housing once an alignment of the elevation angled propagating wave is completed.

14. The assembly of claim 1, wherein the electromagnetic energy antenna further comprises a horn antenna with lens correction.

15. The assembly of claim 10, wherein the reflector tilt mechanism further comprises an elevation adjustment mechanism that adjusts an angle of the reflector surface that adjusts the selected angle of the elevation angled propagating wave.

16. The assembly of claim 15, wherein the elevation adjustment mechanism further comprises an elevation adjuster, external to the housing, that has one or more alignment indication marks so that the elevation of the elevation angled propagating wave is adjustable without opening the housing.

17. The assembly of claim 3, wherein the electromagnetic energy antenna is located in the base.

18. A method for aiming a radiation beam using the integrated compact antenna assembly that has a housing that blends in with a structure on which it is attached and a reflector structure inside of the housing that reflects a vertically propagating wave at a selected elevation angle to generate a elevation angled propagating wave, the method comprising:
rotating the housing to adjust an azimuth angle of the elevation angled propagating wave; and
adjusting the reflector structure inside of the housing to adjust an elevation of the elevation angled propagating wave.

19. The method of claim 18, wherein rotating the housing further comprises stopping, using a tightening mechanism, the rotation of the housing once an alignment of the elevation angled propagating wave is completed.

20. The method of claim 18, wherein adjusting the reflector structure further comprising adjusting an angle of a reflector surface of the reflector structure that adjusts an elevation angle of the elevation angled propagating wave.

21. The method of claim 20, wherein adjusting an angle of a reflector surface of the reflector structure further comprising externally adjusting, using an elevation adjuster, the elevation of the elevation angled propagating wave without opening the housing.

22. An integrated compact millimeter wave radio antenna assembly (“ICA”), comprising:
a fixed base with an adaptor cylinder having an interface with a rotationally adjustable vertically-positioned main cylinder;
an aperture antenna mounted inside the main cylinder and radiating in a vertical direction and having an attached millimeter wave radio front end;
a tilt-angle adjustable reflector mounted inside the main cylinder having a flat reflecting surface in the radiated beam path of the antenna and deflecting the beam to a near level direction; and
a dielectric window in the main cylinder that allows low-loss transmission of the deflected beam out of the main cylinder.

23. The ICA of claim 22, wherein the fixed base has a cable interface connected to a cable leading to an externally mounted radio terminal.

24. The ICA of claim 23, wherein the in which said cable interface has electronic circuitry that forms a complete radio terminal.

25. The ICA of claim 22, wherein the adaptor cylinder includes fasteners for pole top mounting.

26. The ICA of claim 22, wherein the aperture antenna is a lens-corrected horn.

27. The ICA of claim 22, wherein the reflector further comprising a reflecting surface that is contained within an ellipse whose long axis size and position is essentially along the straight line running between the aft point of the radiating aperture and extending to straight above the fore point of the radiating aperture at the highest desired deflection.

28. The ICA of claim 27, wherein the reflector main axis also remains essentially centered above said aperture at the lowest desired deflection.

29. The ICA of claim 28, wherein the center of rotation of said reflector is located behind the reflecting surface.

30. The ICA of claim 29, wherein the center location is essentially at a point formed by the crossing of two straight lines; one of which is the horizontal bisector of the reflecting surface axis center points at highest and lowest deflections and the other line is the obtuse angle bisector between the said main axis highest and lowest deflections.

31. The ICA of claim 22, wherein the dielectric window is shaped like a section of a cylinder.

32. The ICA of claim 31, wherein the dielectric window is made of ABS plastic.

33. The ICA of claim 22, wherein the main cylinder includes a screw for adjusting tilt of the reflector.

34. The ICA of claim 33, wherein the reflector includes a target surface that contacts the screw.

35. The ICA of claim 34, wherein the screw is a thumb screw.

36. The ICA of claim 34, wherein the screw has one or more marking rings wherein each marking ring indicates a different approximate reflector tilt.

37. The ICA of claim 22 further comprising a flexible cable connecting a site on said fixed base with said radio front-end.

38. The ICA of claim 37, wherein the cable includes at least one coaxial cable.
